(19) United States
(12) Patent Application Publication
(10) Pub. No.: US 2005/0184222 A1
(43) Pub. Date: Aug. 25, 2005

(54) Object detecting apparatus and manufacturing method therefor

(76) Inventor: Makoto Inomata, Handa-city (JP)

Correspondence Address: HARNESS, DICKEY & PIERCE, P.L.C., P.O. BOX 828, BLOOMFIELD HILLS, MI, 48303, US

(21) Appl. No.: 11/043,794

(22) Filed: Jan. 26, 2005

(30) Foreign Application Priority Data
Feb. 19, 2004 (JP) 2004-043182

(51) Int. Cl. G06M 7/00; H01J 40/14

(52) U.S. Cl. 250/221

(57) ABSTRACT

An object detecting apparatus comprises a light radiation unit and a light receiver unit disposed in an outer case. The light receiver unit includes a light collecting lens and a light receiving element. The light collecting lens is integrated with an inner case that is disposed in the outer case. The inner case is resin-molded with the light collecting lens by placing the light collecting lens in a pair of dies and injecting resin into the dies. Thus, the optical axis of the light collecting lens is fixed relative to the inner case, and hence it becomes in alignment with the optical axis of the light radiated by the radiation unit when the radiation unit is attached to the inner case.

### CROSS REFERENCE TO RELATED APPLICATION

This application is based on and incorporates herein by reference Japanese Patent Application No. 2004-43182 filed on Feb. 19, 2004.

### FIELD OF THE INVENTION

The present invention relates to an object detecting apparatus mounted on a vehicle, for instance, for detecting an object such as a preceding vehicle or a distance to such an object by using a light wave and to a manufacturing method for the same.

### BACKGROUND OF THE INVENTION

A conventional object detecting apparatus mounted on a vehicle uses a laser light, for instance, to detect an object such as a preceding vehicle or a distance to such an object. This detecting apparatus intermittently drives a laser diode to radiate the laser light towards the forward side of the vehicle, and detects the light reflected from the forward obstacle by a photo sensor. The detecting apparatus measures the distance to the forward obstacle based on a time difference between a light radiation time and a light receiving time.

Specifically, as disclosed in JP 2002-031685A, the detecting apparatus comprises a light radiation unit for radiating a laser light, a polygon mirror and a light receiver unit for receiving a reflected light. The polygon mirror is shaped in a frustum of a hexagonal pyramid and rotatable as a scanning mirror. According to this construction, the polygon mirror reflects the laser light radiated from the light radiation unit and directs it to the forward side of the vehicle. As the polygon mirror is rotated and the laser light from the light radiation unit is directed to each side surface of the polygon mirror, so that the angle of reflection of the laser light at the polygon mirror is adjusted to scan a predetermined range of the forward side of the vehicle by the laser light. The receiver unit includes a Fresnel lens and a light receiving element to receive the laser light reflected from the forward object and measure the distance to the object.

Component parts of the object detecting apparatus are fixed to an inner case made of resin, which is accommodated in an outer case. In fixing the Fresnel lens to the inner case, optical axes of the Fresnel lens and the laser light must be adjusted so that the optical axis of the Fresnel lens coincides with the axis of radiation of the laser light in the radiation unit.

As shown in FIG. 7, in the distance detection circuit, the Fresnel lens J1 has four elongated holes J3 at four corners. Each hole J3 is elongated in the up and down directions. The inner case J2 has two screw holes J4 at two locations opposing diagonally and two positioning projections J5 at two locations diagonally. The screw holes J4 and the projections J5 are provided in facing correspondence with the elongated holes J3.

In the assembling process, two screws J6 are first screwed into the screw holes J4 through the holes J3 while receiving the projections J5 in the holes J3. Thus, the Fresnel lens J1 is tentatively and loosely fit to the inner case J2. The Fresnel lens J1 is then slid in the up and down directions so that the optical axes of the radiated light and the Fresnel lens J1 are adjusted to each other not to deviate from other. The screws J6 are further tightened to finally fix the Fresnel lens J1 to the inner case J2.

The conventional apparatus thus requires the optical axis adjustment of the Fresnel lens J1, resulting in an increased and complication of the assembling process.

### SUMMARY OF THE INVENTION

It is therefore an object of the present invention to provide an object detecting apparatus and a manufacturing method therefor, which simplifies the apparatus and the method.

According to the present invention, an object detecting apparatus comprises a light radiation unit and a light receiver unit disposed in an outer case. The light receiver unit includes a light collecting lens and a light receiving element. The light collecting lens is integrated with an inner case that is disposed in the outer case. The inner case is resin-molded with the light collecting lens by placing the light collecting lens in a pair of dies and injecting resin into the dies. Thus, the optical axis of the light collecting lens is fixed relative to the inner case, and hence it becomes in alignment with the optical axis of the light radiated by the radiation unit when the radiation unit is attached to the inner case.

### BRIEF DESCRIPTION OF THE DRAWINGS

The above and other objects, features and advantages of the present invention will become more apparent from the following detailed description made with reference to the accompanying drawings. In the drawings:

FIG. 1 is a perspective view of an object detecting apparatus according to an embodiment of the present invention;

FIG. 2 is a sectional view of the apparatus shown in FIG. 1;

FIG. 3 is a top plan view of the apparatus shown in FIG. 1;

FIG. 4 is a perspective view of an assembly of a Fresnel lens and an inner case of the apparatus shown in FIG. 1;

FIG. 5 is a sectional view of the assembly along a line V-V in FIG. 4;

FIG. 6 is a sectional view of a manufacturing device used for assembling the Fresnel lens; and

FIG. 7 is a perspective view of an assembly of a Fresnel lens and an inner case of a conventional apparatus.

### DETAILED DESCRIPTION OF THE PREFERRED EMBODIMENT

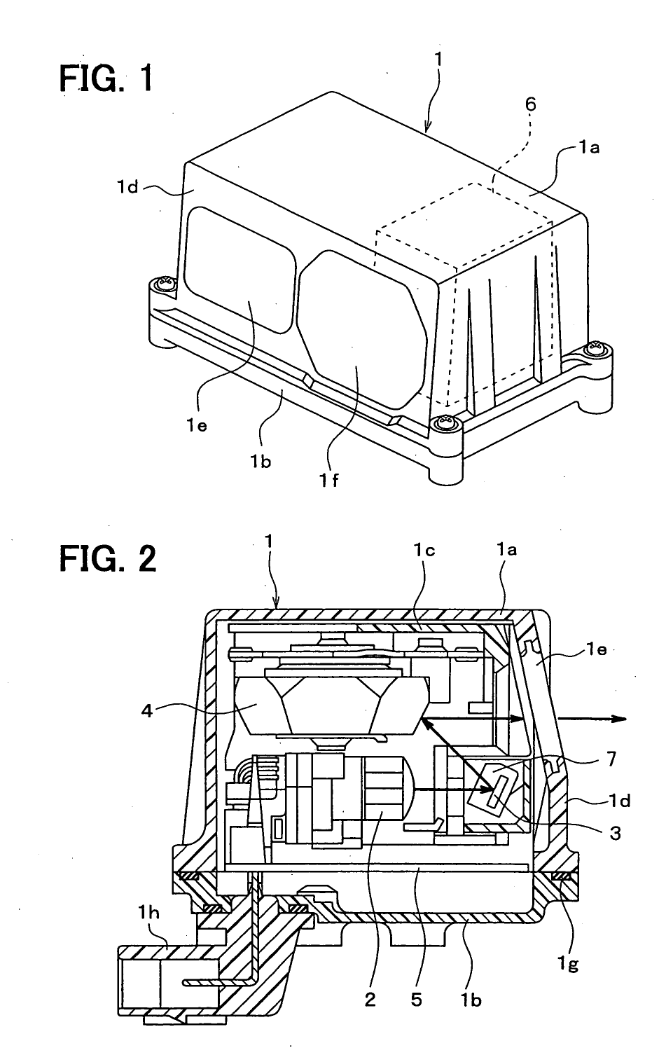

Referring first to FIGS. 1 to 3, an object detecting apparatus includes a case 1 shaped in a cuboid and various component parts accommodated in the case 1. The apparatus is mounted on a vehicle to be used as a laser radar. The apparatus is positioned to radiate a laser light in the forward direction of the vehicle (rightward direction in FIG. 2) to detect a distance to a forward object such as a preceding vehicle during an auto-cruise control condition.

The apparatus includes a first outer case 1a, a second outer case 1b and an inner case 1c. The first case 1a is box-shaped and open at its one side (bottom side in FIG. 2). The first case 1a accommodates therein various component parts. The first case 1a has a resin part 1d made of black PPS resin and form a housing. The first case 1a has a light radiating window 1e and a light receiving window 1f arranged at the left and the right sections on the front-side resin part 1d. The windows 1e and 1f may be made of light transmitting resin such as glass and acrylic resin.

The second case 1b is made of aluminum die-cast and threaded to the first case 1a through a seal member 1g. The second case 1b has an electrical connector 1h made of resin. The connector 1h partly projects from the second case 1b to connect the electrical parts (not shown) provided inside and outside the case 1.

In the case 1, the inner case 1c accommodates a light radiation unit 2, a reflection mirror 3, a polygon mirror 4 and an electric circuit board 5. The circuit board 5 includes an electronic control circuit, which are connected to the light radiation unit 2, a light receiving unit 6 and the like to measure the distance to the forward object. The light receiving unit 6 is positioned inside the case 1 to face the light receiving window 1f and includes a Fresnel lens and a light receiving element.

The light radiation unit 2 is first connected to the inner case 1c and then connected to the second case 1b. The light radiation unit 2 is driven by the control circuit provided on the circuit board 5 and radiates the laser light towards the reflection mirror 3. The light radiation unit 2 may include a laser diode to radiate the laser light in the pulse form.

The reflection mirror 3 reflects the laser light radiated from the radiation unit 3 and directs it to the polygon mirror 4. The reflection mirror 3 is supported swingably to the inner case 1c by a support part 7 fixed to the inside wall of the inner case 1c. For instance, the reflection mirror 3 may be driven by a motor (not shown) and controlled by the electric circuit of the circuit board 5 to adjust the direction of reflection.

The polygon mirror 4 is shaped in a frustum hexagonal prism and supported by the inner case 1c. The mirror 4 is rotatable about an axis of the hexagonal prism. This mirror 4 is also driven by a motor (not shown) controlled by the control circuit of the circuit board 5. The polygon mirror 4 has around its periphery mirror faces, each of which operates as a scanning reflection mirror.

Specifically, the polygon mirror 4 reflects the laser light radiated from the radiation unit 2 and reflected by the reflection mirror 3, and directs the laser light toward the vehicle forward area through the radiating window 1e. As the polygon mirror 4 is rotated, the angle of the side face of the polygon mirror 4 changes. As a result, the angle of projection of the laser light is changed to scan a predetermined forward area of the vehicle.

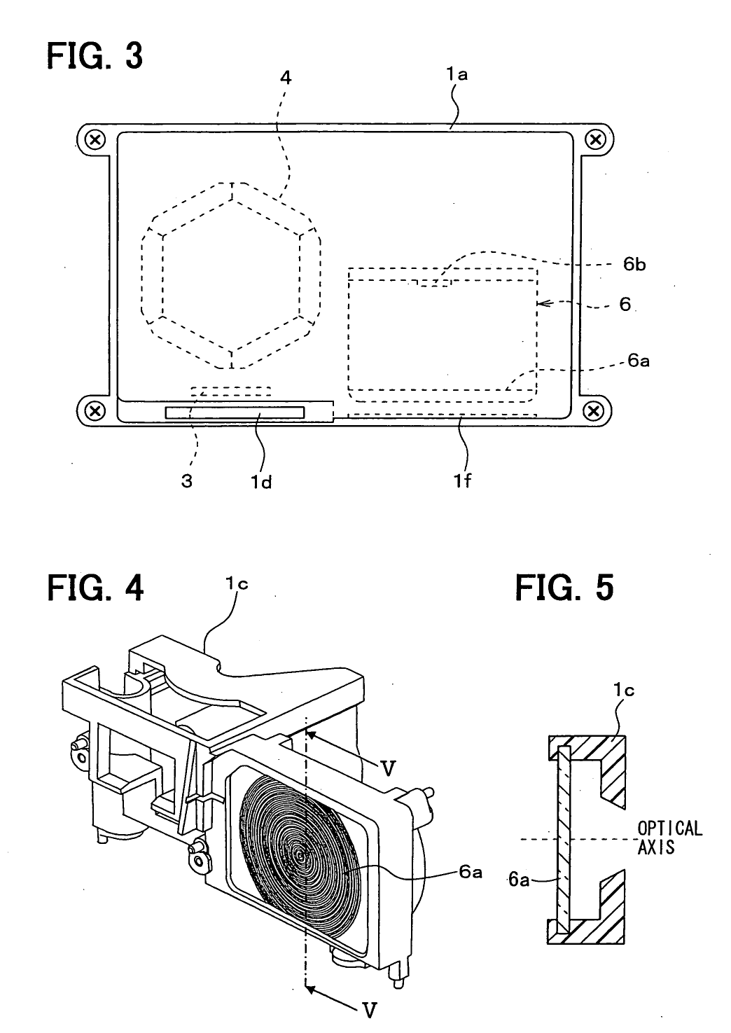

The light receiver unit 6 includes, as shown in FIG. 3, a Fresnel lens 6a and a light receiving element 6b such as a photo diode. The Fresnel lens 6a collects the laser light. The Fresnel lens may be replaced with other lenses that collect reflected laser light. The light receiving element 6b receives the collected light and produces an output voltage or output current varying with the intensity of the received light. The output voltage or current is applied to the control circuit of the circuit board 5.

As shown in FIGS. 4 and 5, the Fresnel lens 6a is integrally molded with the inner case 1c. The peripheral part of the Fresnel lens 6a, specifically the part which does not operate to collect the laser light, is covered with the inner case 1c. Thus, the Fresnel lens 6a is fixed to the inner case 1c. Thus, when the inner case 1c is fixed in position in the first and the second cases 1a and 1b, the Fresnel lens 6a is not displaced. As a result, the optical axis of the Fresnel lens 6a is held in a predetermined positional relation with the optical axis of the laser light radiated through the radiating window 1e.

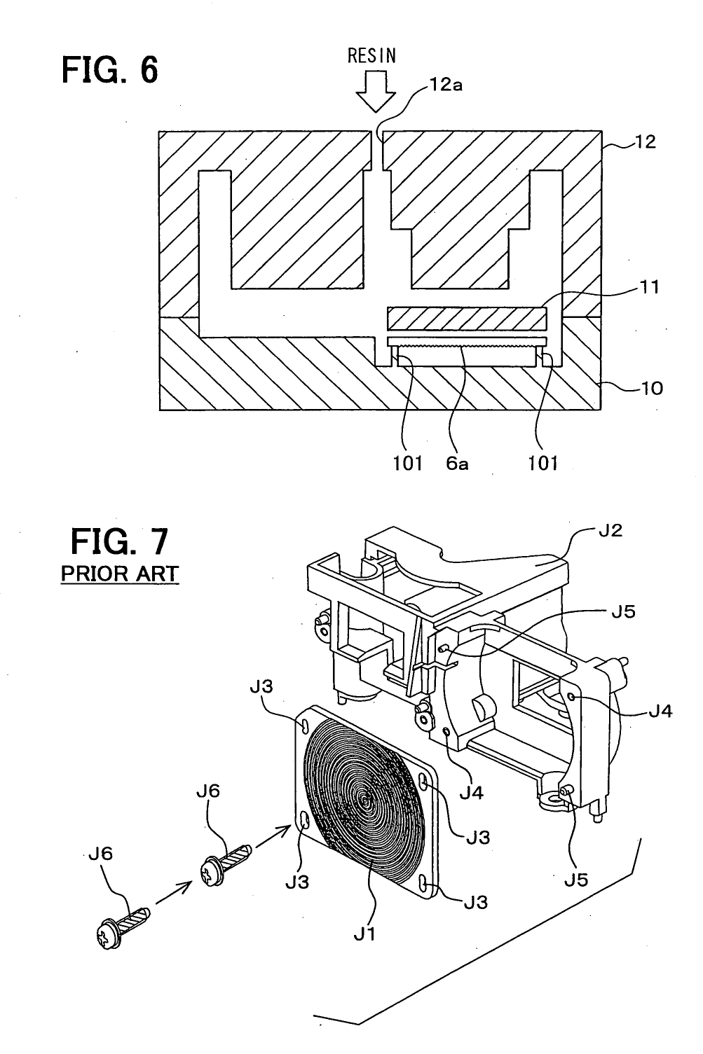

The Fresnel lens 6a and the inner case 1c is integrally molded as shown in FIG. 6. The Fresnel lens 6a is placed at a desired position in a fixed die 10 with its one surface, which is to be directed forward to face the window 1f, directed downward. The fixed die 10 has positioning walls 101 or the like at the position of mounting the Fresnel lens 6a, so that the Fresnel lens 6a is maintained immovably from the desired position in the process of molding.

Next, a sliding die (movable die) 11 is placed above the Fresnel lens 6a in the fixed die 10 so that no resin is injected in the rear side of the Fresnel lens 6a. Thus, a space is provided between the Fresnel lens 6a and the light receiving element 6b. A movable die 12 is placed on the fixed die 10. The fixed die 10, sliding die 11, the movable die 12 and the Fresnel lens 6a are shaped to provide an inner space that corresponds to the inner case 1c in shape.

Resin is injected into the dies 10 and 12 through a resin injection hole 12a. After the injected resin solidifies, the dies 11 and 12 are moved away from the fixed die 10 so that the inner case 1c to which the Fresnel lens 6a is integrally molded is produced.

The injected resin may be in fluid state of about 300° C. If the Fresnel lens 6a is made of resin such as a polycarbonate, which is likely to melt at high temperatures, the Fresnel lens 6a may melt in the injection molding process. Therefore, it is preferred that the temperature of the resin fluid around the Fresnel lens 6a is lowered. For instance, a cooling device may be provided in the sliding die 11 or in a part of the fixed die 10 facing the Fresnel lens 6a.

After the injection molding of the inner case 1c, other parts are assembled to the inner case 1c. Then the inner case 1c is assembled to the second case 1b together with the circuit board 5. The first case 1a is assembled to the second case 1b to cover various parts.

The object detecting apparatus constructed and manufactured as above operates in the following manner, assuming that it is mounted in a vehicle and an auto-cruise control system switch is turned on. The following operation is mostly controlled by the control circuit of the circuit board 5.

The reflection mirror 3 is first driven to a predetermined angular position by the motor. The light radiation unit 2 radiates the laser light at predetermined intervals. The laser light is reflected by the reflection mirror 3 and the polygon mirror 4 to be directed toward the forward area of the vehicle through the radiating window 1e as shown with an arrow in FIG. 2. When the laser light is reflected by an object such as a preceding vehicle, the reflected light passes the light enters the light receiver unit 6 through the light receiving window 1f.

In the light receiver unit 6, the reflected light is collected by the Fresnel lens 6a and received by the light receiving element 6b. The light receiving element 6b generates an output signal in response to the reception of the collected light. Based on this output signal, the control circuit calculates a distance L to the forward object by using the laser light travel speed V and the time difference T between the laser light radiation by the radiation unit 2 and the reception of the laser light by the light receiver unit 6: L=V×T/2.

The calculated distance is output through the connector 1h to various devices such as an engine control ECU and a brake control ECU provided outside the case 1. As a result, the ECUs may control an engine and/or brakes to maintain the distance to the object at a predetermined distance.

According to the above embodiment, the Fresnel lens 6a is integrally molded with the inner case 1c, and the Fresnel lens 6a is protected from displacing from the desired position during the molding process. Therefore, the Fresnel lens 6a is fixedly attached to the inner case 1a such that its optical axis is directed toward a predetermined position. When the light radiation unit 2 and other parts are fixed to the inner case 1c or the cases 1a, 1b, the optical axis of the Fresnel lens 6a is put in a state of correspondence with the optical axis of the laser light radiated by the light radiation unit 2 in a self-aligned manner. As a result, the optical axis adjustment of the Fresnel lens 6a can be obviated and the manufacturing process of the apparatus is simplified.

The present invention should not be limited to the above embodiment, but may be implemented in many other ways.

1. An object detecting apparatus for detecting an object, the apparatus comprising:
an outer case having a light radiating window and a light receiving window;
a light radiation unit disposed in the outer casing for radiating a light outward from the outer case through the light radiating window;
a light receiver unit disposed in the outer case and having a light collecting lens and a light receiving element, the light collecting lens being for collecting the light reflected by the object and passing the light receiving window, and the light receiving element being for receiving the light collected by the light collecting lens; and
an inner case disposed in the outer case and fixedly integrating the light collecting lens at a predetermined position

2. The object detecting apparatus as in claim 1, wherein the inner case is resin-molded with the light collecting lens such that the inner case is fixed with only a periphery of the light collecting lens.

3. The object detecting apparatus as in claim 1, wherein the light collecting lens is a Fresnel lens.

4. A manufacturing method for an object detecting apparatus, the apparatus including an outer case having a light radiating window and a light receiving window, a light radiation unit disposed in the outer casing for radiating a light through the light radiating window, a light receiver unit disposed in the outer case and having a light collecting lens and a light receiving element, and an inner case disposed in the outer case, the method comprising:
placing the light collecting lens at a predetermined position in a fixed die;
placing a movable die on the fixed die to cover the light collecting lens therein; and
injecting resin in a space defined by the fixed die and the movable die to mold the inner case integrally with the light collecting lens.

5. The manufacturing method as in claim 4, further comprising:
cooling, while injecting the resin, a part of the space where the light collecting lens is placed.
